(19) United States
(12) Patent Application Publication
(10) Pub. No.: US 2014/0255590 A1
(43) Pub. Date: Sep. 11, 2014

(54) FOOD ADDITIVE FOR PROTEIN-BASED PRODUCTS

(71) Applicant: VAN HEES, INC., Cary, NC (US)

(72) Inventors: Michael D. Carson, Arlington Heights, IL (US); Deanna L. Hofing, Coatesville, IN (US)

(73) Assignee: Van Hees, Inc., Cary, NC (US)

(21) Appl. No.: 13/790,222

(22) Filed: Mar. 8, 2013

(51) Int. Cl. A23B 4/20

(52) U.S. Cl. CPC A23B 4/20
USPC 426/652

(57) ABSTRACT

The present invention provides a food additive composition that comprises a natural replacement for sodium phosphate. The natural replacement for sodium phosphate may be one or more natural sources of polysaccharides and/or starches (e.g., trehalose or plant-derived fibers). In one embodiment, the natural replacement for sodium phosphate is a combination of a first natural source of polysaccharides or starches and a second natural source of polysaccharides and/or starches, and includes a component for adjusting the pH (e.g., sodium carbonate), and optionally, a dry flavor masking agent such as a dry source of acetic acid (e.g., vinegar powder).

### FIELD AND BACKGROUND OF THE INVENTION

The present invention relates to a food additive, and more particularly to a food additive that can be used to enhance and/or maintain various properties of protein-based food products.

There is a demand in the food industry to provide consumers with so-called “all natural” alternatives to conventional products, particularly food additives. Not only do these products need to have an appearance similar to their artificial counterpart, but also maintain similar characteristics such as stability, taste, and cost. The challenges of developing these products are many fold. For example, the number of natural raw materials is limited. The options for “natural” raw materials are not well defined by USDA/FSIS. Moreover, natural materials may not be as effective as conventional (non-naturally derived) materials. A specific example of this is the use of sodium phosphate as an additive. Sodium phosphate is not a natural additive but replacements for it are limited.

### SUMMARY OF THE INVENTION

To this end, the present invention provides a natural food additive that can enhance and/or maintain various properties of protein-based foods including taste, stability, texture, water-holding capacity masking off-notes, and the like. In one embodiment, the food additive composition comprises at least one nature replacement for sodium phosphate comprising a natural source of polysaccharides (e.g., trehalose or plant-derived fibers), a component for adjusting the pH, and optionally, a dry flavor masking agent.

In another embodiment, the food additive comprises a first natural source of polysaccharides (e.g., trehalose) and a second natural source of polysaccharides (e.g., plant-derived fibers), a component for adjusting the pH, and optionally, a dry flavor masking agent.

### BRIEF DESCRIPTION OF THE DRAWINGS

FIG. 1 is a bar graph showing Overall Yield of 20% injected pork loins cooked in a smokehouse according to Examples 1-4.

FIG. 2 is a bar graph showing Overall Yield of 20% injected roast beef cooked in a smokehouse according to Examples 1-4.

FIG. 3 is a bar graph showing Overall Yield of 20% injected turkey breast cooked in a smokehouse according to Examples 1-4.

FIG. 4 is a bar graph showing Overall Yield of 20% injected chicken breast cooked in an oven and in a smokehouse according to Examples 1-4.

FIG. 5 is a bar graph showing Overall Yield of 20% injected turkey breast cooked in a smokehouse according to Examples 5 and 6.

FIG. 6 is a bar graph showing Overall Yield of 20% injected chicken breast cooked in a smokehouse according to Examples 5 and 6.

FIG. 7 is a bar graph showing Overall Yield of 20% injected chicken breast cooked in a smokehouse according to Examples 7 and 8.

FIG. 8 is a bar graph showing Chilling Loss of 20% injected chicken breast cooked in a smokehouse according to Examples 7 and 8.

FIG. 9 is a bar graph showing Overall Yield of 20% injected beef sirloin cooked in an oven and in a smokehouse according to Examples 9 and 10.

FIG. 10 is a bar graph showing Cooked Yield of 20% injected beef sirloin cooked in an oven and in a smokehouse according to Examples 9 and 10.

FIG. 11 is a bar graph showing Overall Yield and Cooked Yield of 20% injected hams cooked in a smokehouse according to Examples 9 and 10.

FIG. 12 is a bar graph showing Overall Yield of 20% injected pork loin cooked in an oven and in a smokehouse according to Examples 9 and 10.

FIG. 13 is a bar graph showing Cooked Yield of 20% injected pork loin cooked in an oven and in a smokehouse according to Examples 9 and 10.

FIG. 14 is a bar graph showing Overall Yield of 20% injected turkey breast cooked in an oven and in a smokehouse according to Examples 9 and 10.

FIG. 15 is a bar graph showing Cooked Yield of 20% injected turkey breast cooked in an oven and in a smokehouse according to Examples 9 and 10.

### DETAILED DESCRIPTION OF THE INVENTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items. Furthermore, the term “about,” as used herein when referring to a measurable value such as an amount of a compound, dose, time, temperature, and the like, is meant to encompass variations of 20%, 10%, 5%, 1%, 0.5%, or even 0.1% of the specified amount. Unless otherwise defined, all terms, including technical and scientific terms used in the description, have the same meaning as commonly understood by one of ordinary skill in the art to which this invention belongs.

All patents, patent applications and publications referred to herein are incorporated by reference in their entirety. In case of a conflict in terminology, the present specification is controlling.

The present invention provides a food additive composition that comprises a natural replacement for sodium phosphate. The natural replacement for sodium phosphate may be one or more natural sources of polysaccharides and/or starches (e.g., trehalose or plant-derived fibers). In one embodiment, the natural replacement for sodium phosphate is a combination of a first natural source of polysaccharides or starches and a second natural source of polysaccharides and/or starches, and includes a component for adjusting the pH (e.g., sodium carbonate), and optionally, a dry flavor masking agent such as a dry source of acetic acid (i.e., vinegar powder). The “sources” of the first and second natural sources of polysaccharide can be an actual mono-, di-, or polysaccharide or can be a starch or can break down into a polysaccharide or starch. The food additive composition of the present invention provides a natural food additive for various food products and is an alternative to existing additives. The food additive composition of the invention enhances or maintains the properties and characteristics as compared to existing non-natural additives. Exemplary properties and characteristics include avoidance of discoloration and/or oxidation, improved taste, texture, masking or suppression of off-notes, stability, succulence, lipid stabilization, and water holding capacity.

Water holding or binding capacity is a particular concern with respect to protein-based foods such as meat. Non-natural phosphates such as sodium phosphate are often used to maintain or improve the water holding capacity of meat. Sodium phosphate; however, is not regarded as a natural product, and some tasting experts believe that phosphates alter the texture and flavor of meats. Thus the present invention provides a substitute specific to phosphates and particularly sodium phosphate. Moreover, the present invention provides a food additive composition that is effective in increasing the total water holding capacity of a foodstuff by at least 15 percent by weight.

The term “foodstuff” is intended to mean a substance which is suitable for human or animal consumption, and includes animal foods (e.g., dog and cat food), sauces and gravies, soups, casseroles, and protein-based foods. Protein-based foods, namely sources of protein, include meat, poultry, fish, eggs and dairy products, soy and quinoa. The term “meat” is intended to include, but not be limited to, beef, bison, venison, lamb, pork, rabbit or other game meat, and the like. The term “poultry” is intended to include, but not be limited to, chicken, turkey, duck, pheasant or other game birds, and the like. The term “fish” is intended to include, but not be limited to, both fish and shellfish such as shrimp, scallops, mussels, salmon, tuna, cod, swordfish, tilapia, and the like.

In one embodiment, the food additive composition comprises 80 to 95 percent by weight of a natural replacement for sodium phosphate comprising 45 to 65 percent by weight of a first natural source of polysaccharides and/or starches and 25 to 35 percent by weight of a second natural source of polysaccharides and/or starches; 5 to 15 percent by weight of a component for adjusting pH; 0 to 5 percent by weight of a dry flavor masking agent (e.g., a dry source of acetic acid); 0 to 5 percent by weight of other natural flavors or additives; and 0.1 to 2 percent by weight anti-caking agent (e.g., silicon dioxide).

Natural additives include functional additives such as emulsifiers, stabilizers (e.g., xanthum gum), starches, proteins, fibers, preservatives, antioxidants, colorants, and antimicrobials. Preferably these additives are on the GRAS list issued by the FDA.

In one embodiment, the additive may further include a source of vegetable protein that is preferably allergen-free. An exemplary source of vegetable protein is a pea-based additive such as pea protein, pea starch, and/or pea fiber. Other sources of vegetable protein includes artichokes, beets, broccoli, brussel sprouts, cabbage, cauliflower, cucumbers, eggplant, green pepper, kale, lettuce, mushrooms, mustard greens, onions, spinach, turnip greens, watercress, yams, and zucchini.

In one embodiment, the first natural source of polysaccharides and/or starches is trehalose. Trehalose is a natural-occurring non-reducing saccharide derived from corn starch and other natural sources of starch using an enzymatic process. An exemplary trehalose is marketed under the trademark Treha™ by Hayashibara, Okuyama, Japan and is a highly purified dehydrate crystalline trehalose.

The second natural source of polysaccharides and/or starches may be a plant-derived fiber or powder such as psyllium fiber, psyllium husk fiber, carrot fiber, oat fiber, oat bran fiber, sugar cane fiber, wheat fiber, wheat starch powder (e.g., Fibersym® RW), inulin, and the like.

In one embodiment, sodium carbonate is added as a component for adjusting pH. By adjusting the pH, the water holding capacity of muscle protein can be increased.

The dry source of acetic acid is typically dry vinegar powder. A suitable dry vinegar powder is available from Naturex, Avignon, France. Other dry sources of acetic acid include dry citrus juice (e.g., lemon juice powder).

The food additive is added to the foodstuff in a form and method known to those skilled in the art. For example, the additive can be in the form of a powder, granular blend, or a liquid, and can be applied to or mixed with the foodstuff using kneading, blending, spraying, injecting, and the like.

The following examples are illustrative of the invention and are not limiting thereof.

### Examples

Compositions of the present invention were compared to sodium phosphate.

All meat was provided by the University of Wisconsin, Madison, and was not enhanced. The formulations for the Comparative Example and Examples 1-4 are provided in Table A. Examples 1-4 demonstrate the synergy of using the combination of a first natural source of polysaccharides (trehalose) and a second natural source of polysaccharides (plant-derived psyillium).

TABLE A

| | | | |
|---|---|---|---|
| Ingredient | Range formula | % in Brine | % in Final |

Comparative Example

| | | |
|---|---|---|
| Potassium | 1.80% | 0.300% |
| Tripolyphosphate | | |
| Salt | 5.00% | 0.833% |

Example 1

| | | | |
|---|---|---|---|
| Trehalose | 39.4% | 0.79% | 0.131% |
| Sodium Carbonate | 30.0% | 0.60% | 0.100% |
| Psyllium | 30.0% | 0.60% | 0.100% |
| Xanthan | 0.6% | 0.01% | 0.002% |

Example 2

| | | | |
|---|---|---|---|
| Trehalose | 54.4% | 1.09% | 0.181% |
| Sodium Carbonate | 15.0% | 0.30% | 0.050% |
| Psyllium | 30.0% | 0.60% | 0.100% |
| Xanthan | 0.6% | 0.01% | 0.002% |

Example 3

| | | | |
|---|---|---|---|
| Trehalose | 64.4% | 1.29% | 0.215% |
| Vinegar Powder | 5.0% | 0.10% | 0.017% |
| Psyllium | 30.0% | 0.60% | 0.100% |
| Xanthan | 0.6% | 0.01% | 0.002% |

Example 4

| | | | |
|---|---|---|---|
| Trehalose | 69.4% | 1.39% | 0.231% |
| Psyllium | 30.0% | 0.60% | 0.100% |
| Xanthan | 0.6% | 0.01% | 0.002% |

On the day of injection, all meats were defrosted and kept at a temperature of about 40° F. Meats were cut into manageable sizes for the injector and weights were recorded as “Green Weight.” All meats were run at the following injector settings:

Liquid Pressure: ˜1.0 bars

Track Speed: ˜15 units

Passes: ˜2 per piece

Needle Size: 4 mm

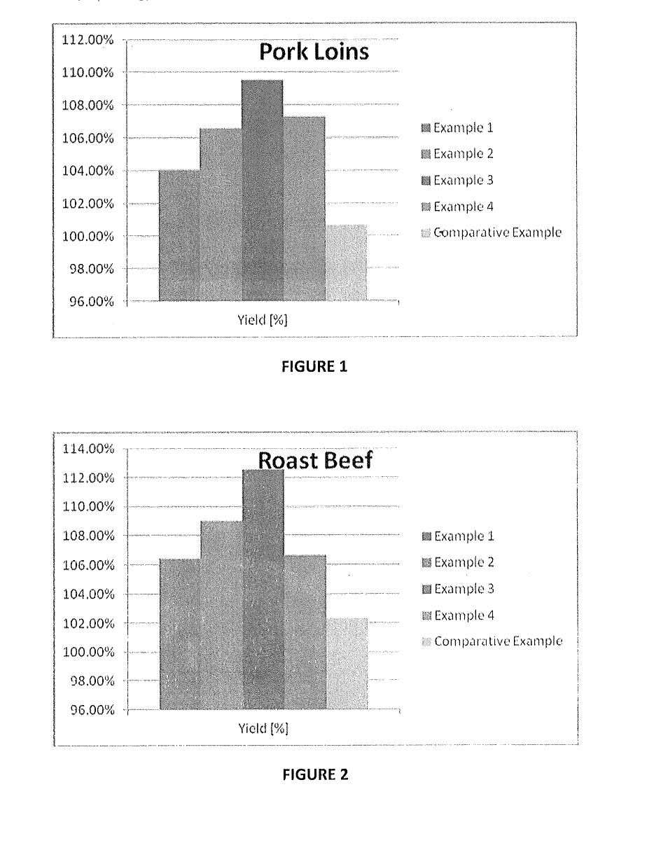

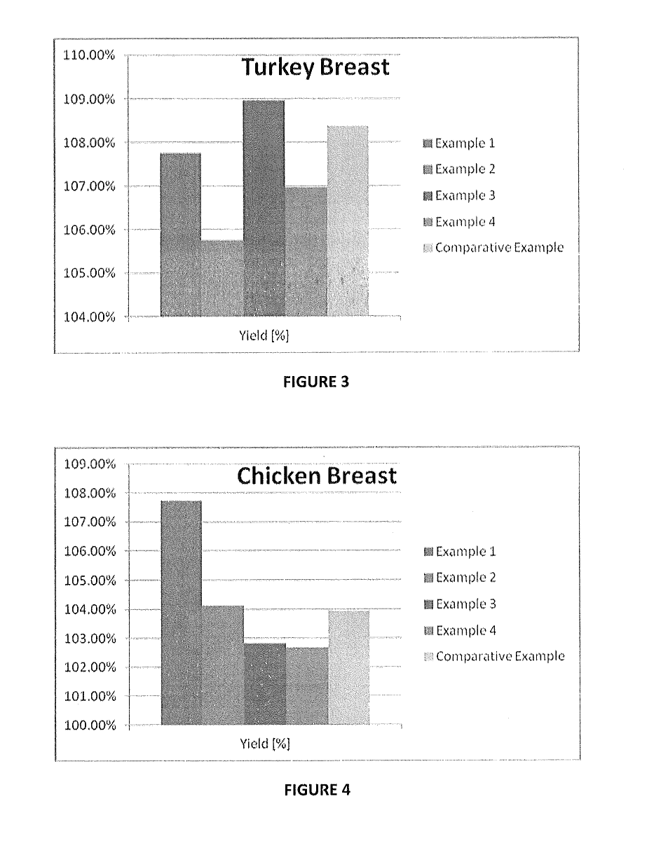

After injection, meat weights were recorded as “Injected Weight” and batch tumbled at 8 RPMs for 45 minutes for the following lengths of time based on the application being tested: The meat weights were recorded as “Tumbled Weight” and moved to the cooler to rest overnight to challenge their ability to hold the injected brine prior to cooking. The following morning weights were recorded again as “Drip Weight” and the meats were moved to vacuumed sealed cook-in bags prior to being placed in the smokehouse (Smokehouse or Oven).
The hams were all cooked in the smokehouse, as cooking them in the oven is not a realistic preparation method. Oven temperature was set to 300° F. Meats were placed in cook-in bags on baking sheets and cooked until desired internal temperature was achieved. All meats cooked in the smokehouse utilized the following cook cycle:
1. Steam cook at 145° F. for 60 minutes.
2. Steam cook at 155° F. for 60 minutes.
3. Steam cook at 165° F. for 60 minutes or until product reaches desired internal temperature.
4. Steam cook at 170 until product reaches desired internal temperature.
5. 30 minute Cooling shower.
   Desired internal temperature of each application was set as follows:
Pork Loins: 150° F.
Roast Beef: 150° F.
Turkey Breast: 162° F.
Chicken: 162° F.
   Upon completion of the cooking cycle, the meats were removed from the bags and weights recorded as “Cooked Weight.” The results for pork loin, roast beef, turkey breast, and chicken breast are shown in FIGS. 1-4 and demonstrate the improved total water holding capacity aspect of the food additive composition of the invention for a variety of meats.

Examples 5 and 6 demonstrate the synergistic combination of trehalose as the first natural polysaccharide and potato starch (maltodextrin) as the second natural polysaccharide and formulations are shown in Table B.

TABLE B

| | | | |
|---|---|---|---|
| Ingredient | Range formula | % in Brine | % in Final |

Example 5

| | | | |
|---|---|---|---|
| Trehalose | 30.0% | 0.60 | 0.1002 |
| Potato Starch | 50.0% | 1.00 | 0.1670 |
| Vinegar Powder | 20.0% | 0.40 | 0.0668 |

Example 6

| | | | |
|---|---|---|---|
| Trehalose | 30.0% | 0.90 | 0.150 |
| Potato Starch | 40.0% | 1.20 | 0.200 |
| Sodium Carbonate | 10.0% | 0.30 | 0.050 |
| Vinegar Powder | 20.0% | 0.60 | 0.100 |

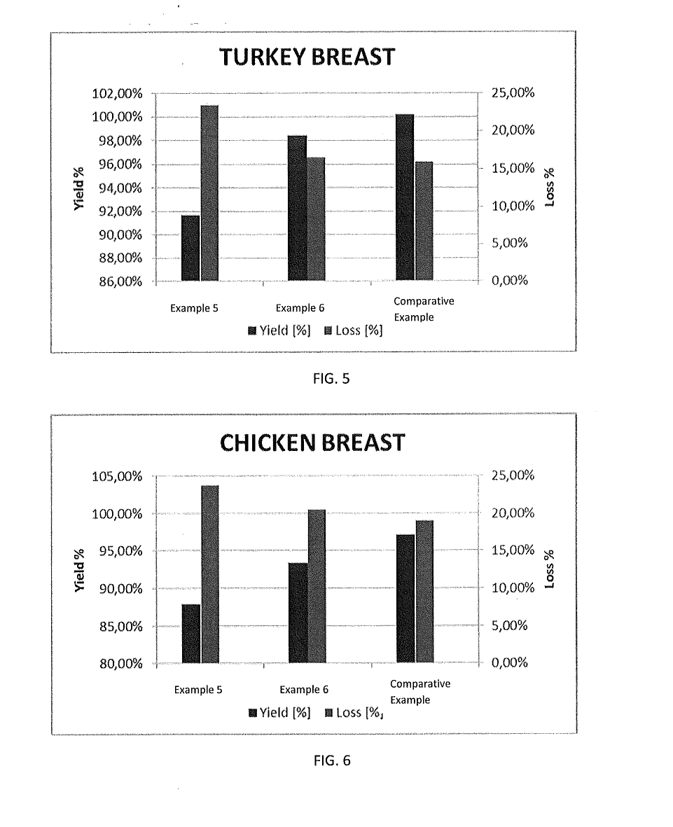

On the day of injection, all poultry were refrigerated and kept at a temperature of 36° F. The chicken and turkey breasts were trimmed and weights were recorded as Green Weight. All pieces were run at the following injector settings:
Liquid Pressure: 1.0 bar
Passes: 2 per piece
   After injection, meat weights were recorded as Injected Weight and each batch was tumbled at 8 RPM for 45 minutes.
   The meat weights were recorded as “Tumbled Weight” and moved to the cooler to rest overnight for 24 hours to challenge their ability to hold the injected brine prior to cooking. The following morning weights were recorded again as “Drip Weight” and the meats were moved to cook-in bags prior to the cooking process.
   The smokehouse temperatures were set as follow:
1. Steam cook at 145° F. for 60 minutes.
2. Steam cook at 155° F. for 60 minutes.
3. Steam cook at 165° F. for 60 minutes or until product reaches desired internal temperature.
4. Steam cook at 170° F. until product reaches desired internal temperature.
5. 30 minute Cooling shower.
   The internal core temperature was set to 165° F.
   Upon completion of the cooking cycle, the products were reweighed and recorded as “Cooked Weight.” For the treatments of the November testing (−210, −211 and control) half of the products were reweighed as “Cooked green weight”, vacuum sealed, and refrigerated for another 24 hours to determine the chilling loss. The following morning the weights were recorded again as “Cooked drip weight.” The other half was taken for warm tasting purposes. Results are shown in FIGS. 5 and 6.

Examples 7 and 8 demonstrate the synergistic combination of treahalose, potato starch, psyllium, and pea fiber and formulations are shown in Table C.

TABLE C

| | | | |
|---|---|---|---|
| Ingredient | Range formula | % in Brine | % in Final |

Example 7

| | | | |
|---|---|---|---|
| Trehalose | 12.0% | 0.60 | 0.0996 |
| Potato Starch | 39.4% | 1.97 | 0.3270 |
| Psyllium | 10.0% | 0.50 | 0.083 |
| Pea Fiber | 20.0% | 1.00 | 0.166 |
| Sodium Carbonate | 6.0% | 0.30 | 0.0498 |
| Vinegar Powder | 12.0% | 0.60 | 0.0996 |
| Xanthan Gum | 0.6% | 0.03 | 0.00498 |

Example 8

| | | | |
|---|---|---|---|
| Trehalose | 12.0% | 0.60 | 0.0996 |
| Potato Starch | 59.8% | 2.99 | 0.4963 |
| Psyllium | 10.0% | 0.50 | 0.083 |
| Sodium Carbonate | 10.0% | 0.50 | 0.083 |
| Vinegar Powder | 12.0% | 0.60 | 0.0996 |
| Xanthan Gum | 0.2% | 0.01 | 0.0017 |

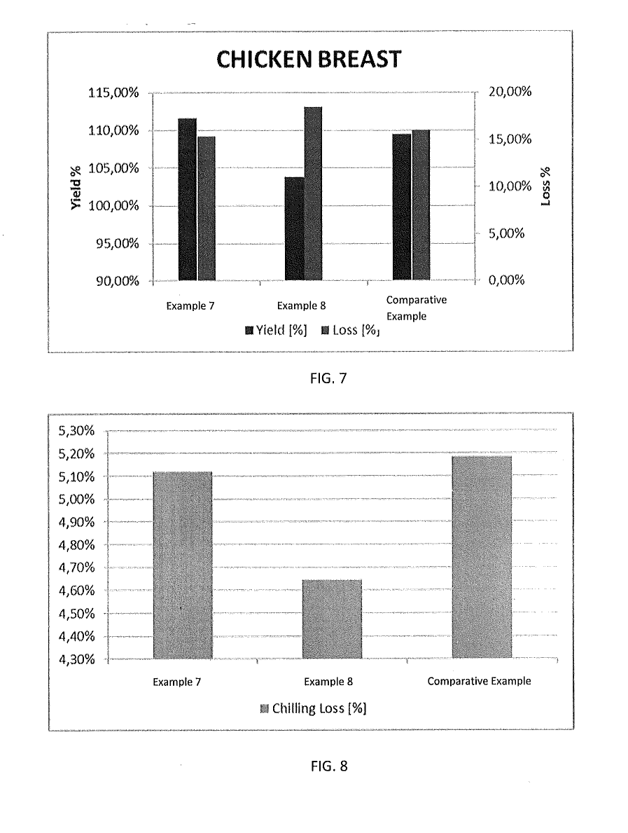

The injection settings and smokehouse temperatures and the like for chicken breast, were the same as Examples 5 and 6. For the Chilling Loss, products were vacuumed sealed and refrigerated for 24 hours. Results are shown in FIGS. 7 and 8.

Examples 9 and 10 demonstrate the effectiveness of trehalose by itself.

All meat was provided by the University of Wisconsin, Madison, and was not enhanced. The Control was 1% fine flake salt from Cargill and 0.3% sodium phosphate. Examples 9 and 10 were 1% fine flake salt, 87% trehalose, and 90.3% trehalose, respectively.

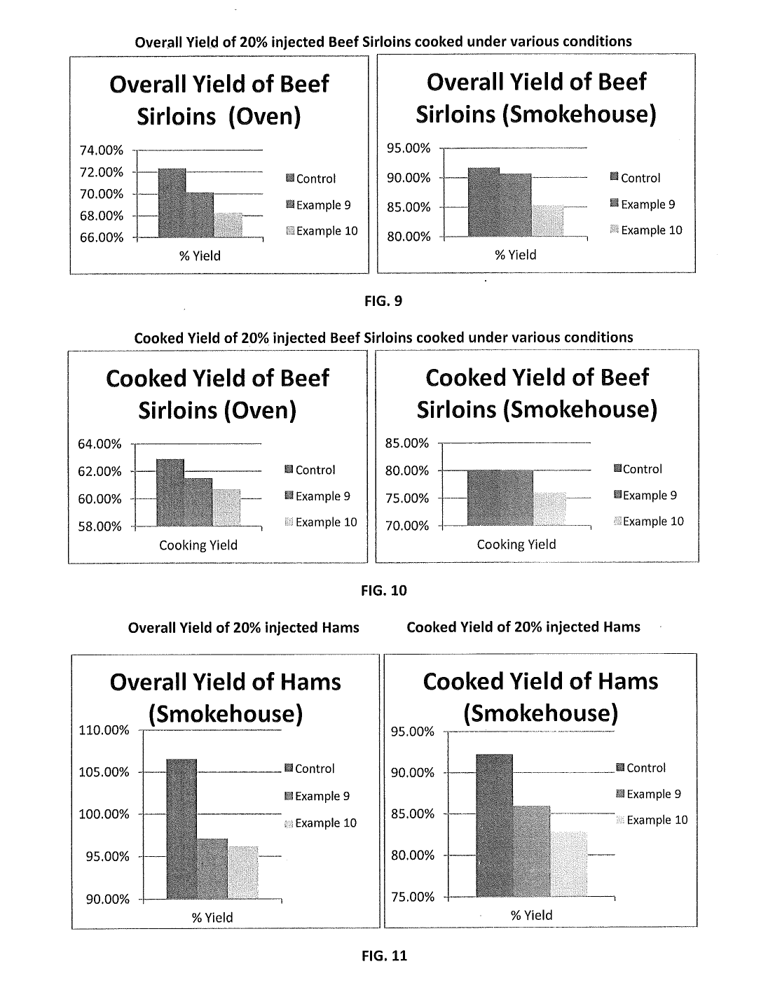

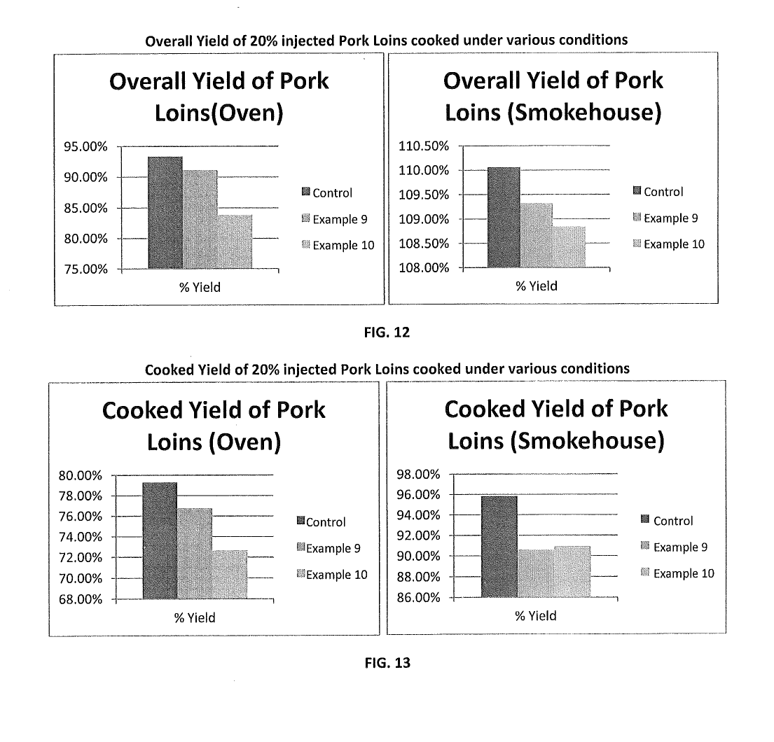

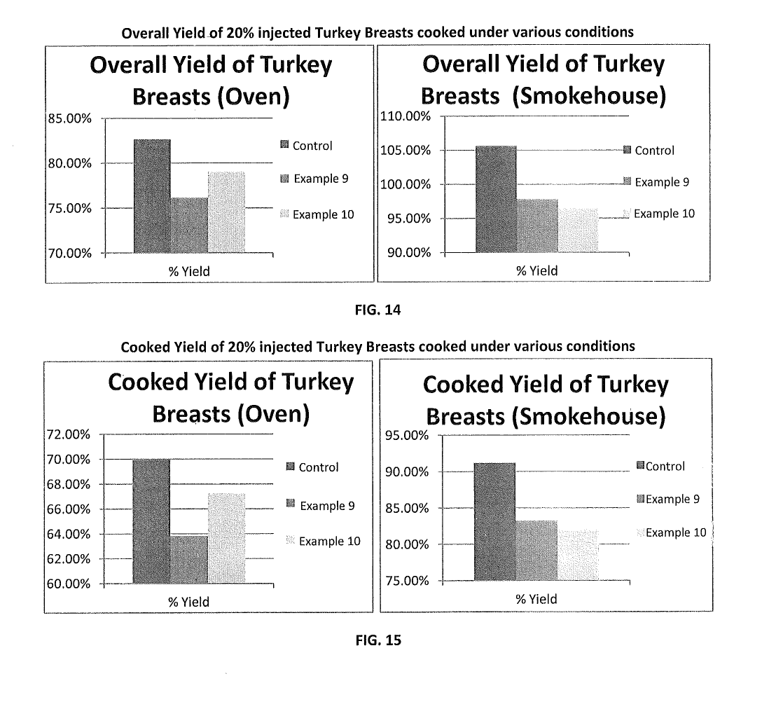

On the day of injection, all meats were defrosted and kept at a temperature of about 40° F. Meats were cut into manageable sizes for the injector and weights were recorded as “Green Weight.” All meats were run at the following injector settings:
Liquid Pressure: ˜2.5 bars
Track Speed: ˜15 units
Passes: ˜2 per piece
Needle Size: 4 mm
   After injection, meat weights were recorded as “Injected Weight” and batch tumbled at 20 RPMs for the following lengths of time based on the application being tested:
Roast Beef for 12 minutes
Ham (Pork) for 30 minutes
Pork Loins for 12 minutes
Turkey Breasts for 25 minutes
   The meat weights were recorded as “Tumbled Weight” and moved to the cooler to rest overnight for at least 12 hours to challenge their ability to hold the injected brine prior to cooking. The following morning weights were recorded again as “Drip Weight” and the meats were moved to cook-in bags prior to either of the two cooking process (Smokehouse or Oven). The Hams were all cooked in the smokehouse, as cooking them in the oven is not a realistic preparation method. Oven temperature was set to 300° F. Meats were placed in cook-in bags on baking sheets and cooked until desired internal temperature was achieved. All meats cooked in the smokehouse utilized the following cook cycle:
6. Steam cook at 145° F. for 60 minutes.
7. Steam cook at 155° F. for 60 minutes.
8. Steam cook at 165° F. for 60 minutes or until product reaches desired internal temperature.
9. Steam cook at 170° F. until product reaches desired internal temperature.
10. Cooling shower.
   Desired internal temperature of each application was set as follows:
Roast Beef: 160° F.
Hams: 162° F.
Pork Loins: 150° F.
Turkey Breast: 162° F.
   Upon completion of the cooking cycle, products were moved to the cooler to rest overnight for at least 12 hours. This step was not taken for the ham or the beef cooked in the Oven. These were weighed immediately upon completion of the cooking cycle with no rest. The meats were then removed from the bags and weights recorded as “Cooked Weight.” The results are shown in FIGS. 9-15 and demonstrate the improved total water holding capacity aspect of the food additive composition of the invention.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed.

That which is claimed:

1. A food additive composition for protein-based food products comprising:
(a) 80 to 95 percent by weight a natural replacement for sodium phosphate and/or starches comprising a first natural source of polysaccharides and a second natural source of polysaccharides and/or starches;
(b) 5 to 15 percent by weight component for adjusting pH;
(c) 1 to 5 percent by weight dry flavor masking agent;
(d) 0 to 5 percent by weight of natural additive; and
(e) 0 to 2 percent by weight anti-caking agent.

2. The food additive composition according to claim 1, wherein the component for adjusting pH is sodium carbonate.

3. The food additive according to claim 1, wherein the dry flavor masking agent is a dry source of acetic acid.

4. The food additive according to claim 3, wherein the dry source of acetic acid is dry vinegar powder.

5. The food additive composition according to claim 1 further comprising a source of vegetable protein.

6. The food additive composition according to claim 2 further comprising a source of vegetable protein.

7. A food additive composition according to claim 5, wherein the source of vegetable protein is a pea-based additive selected from the group consisting of pea protein, pea starch, and/or pea fiber.

8. A food additive composition according to claim 1, wherein the composition increases the total water holding capacity of a protein-based foodstuff by at least 15 percent by weight.

9. The food additive composition according to claim 1, wherein the anti-caking agent is silicon dioxide.

10. The food additive composition according to claim 1, wherein the first natural source of polysaccharides and/or starches is trehalose and the second natural source of polysaccharides and/or starches is a plant-derived fiber or powder.

11. The food additive composition according to claim 10, wherein the plant-derived fiber or powder is selected from the group consisting of psyllium fiber, psyllium husk fiber, carrot fiber, oat fiber, oat bran fiber, sugar cane fiber, wheat fiber, wheat starch powder, and inulin.

12. A foodstuff having improved total water holding capacity, the foodstuff comprising:
(a) a source of protein; and
(b) a food additive composition comprising 80 to 95 percent by weight a natural replacement for sodium phosphate comprising a first natural source of polysaccharides and/or starches, and a second natural source of polysaccharides and/or starches, 5 to 15 percent by weight of a component for adjusting pH, 1 to 5 percent by weight dry flavor masking agent, 0 to 5 percent by weight of natural additive, and 0.1 to 2 percent by weight anti-caking agent.

13. The foodstuff according to claim 12 wherein the component for adjusting the pH is sodium carbonate, the dry flavor masking agent is dry vinegar powder, and the anti-caking agent is silicon dioxide.

14. The foodstuff according to claim 12, wherein the first natural source of polysaccharides and/or starches is trehalose and the second natural source of polysaccharides and/or starches is a plant-derived fiber or powder.

15. The foodstuff according to claim 14, wherein the plant-derived fiber or powder is selected from the group consisting of psyllium fiber, psyllium husk fiber, carrot fiber, oat fiber, oat bran fiber, sugar cane fiber, wheat fiber, wheat starch powder, and inulin.

16. A food additive composition for protein-based food products comprising:
(a) 80 to 95 percent by weight a natural replacement for sodium phosphate and/or starches comprising at least one natural source of polysaccharides;
(b) 5 to 15 percent by weight component for adjusting pH;
(c) 1 to 5 percent by weight dry flavor masking agent;
(d) 0 to 5 percent by weight of natural additive; and
(e) 0 to 2 percent by weight anti-caking agent.

17. The food additive composition according to claim 16, wherein the component for adjusting pH is sodium carbonate.

18. The food additive according to claim 16, wherein the dry flavor masking agent is a dry source of acetic acid.

19. The food additive according to claim 18, wherein the dry source of acetic acid is dry vinegar powder.

20. The food additive composition according to claim 16 further comprising a source of vegetable protein.

21. A food additive composition according to claim 20, wherein the source of vegetable protein is a pea-based additive selected from the group consisting of pea protein, pea starch, and/or pea fiber.

22. A food additive composition according to claim 16, wherein the composition increases the total water holding capacity of a protein-based foodstuff by at least 15 percent by weight.

23. The food additive composition according to claim 16, wherein the anti-caking agent is silicon dioxide.

24. The food additive composition according to claim 16, wherein the natural source of polysaccharides is trehalose or a plant-derived fiber or powder is selected from the group consisting of psyllium fiber, psyllium husk fiber, carrot fiber, oat fiber, oat bran fiber, sugar cane fiber, wheat fiber, wheat starch powder, and inulin.

25. A foodstuff having improved total water holding capacity, the foodstuff comprising a source of protein and a food additive composition according to claim 16.
